(19) United States
(12) Patent Application Publication
(10) Pub. No.: US 2015/0236379 A1
(43) Pub. Date: Aug. 20, 2015

(54) ADDITIVES FOR GALVANIC CELLS

(71) Applicant: ROCKWOOD LITHIUM GMBH, Frankfurt am Main (DE)

(72) Inventors: Ulrich Wietelmann, Friedrichsdorf (DE); Christoph Harting, Eppstein (DE); Ute Emmel, Frankfurt am Main (DE)

(21) Appl. No.: 14/433,108

(22) PCT Filed: Oct. 9, 2013
(86) PCT No.: PCT/EP2013/003026

§ 371 Date: Apr. 2, 2015

(30) Foreign Application Priority Data
Oct. 11, 2012 (DE) 10 2012 218 496.1

(51) Int. Cl. H01M 10/0567; H01M 10/0568; H01M 10/052

(52) U.S. Cl. CPC H01M 10/0567; H01M 10/052; H01M 10/0568; H01M 2300/0025

(57) ABSTRACT

Additives for galvanic cells wherein fluorine-free sodium, potassium, cesium, and/or rubidium salts that are soluble in polar organic solvents are used as electrolyte components (additives).

The subject matter of the invention relates to additives for galvanic cells.

Mobile electronic devices require increasingly powerful rechargeable batteries for a self-sufficient power supply. In addition to nickel/cadmium and nickel/metal anhydride batteries, lithium batteries that have a significantly higher energy density in comparison to the first-mentioned systems are particularly suitable for these purposes. In the future, lithium batteries are also to be used on a large scale, for example, for stationary applications (power back-up) and in the automotive field for traction purposes (hybrid drive or pure electric drive). Lithium-ion batteries are currently being developed and used for this purpose, in which a graphitic material is employed as the anode. As a rule, graphite anodes in the charged state cannot intercalate more than 1 lithium atom per 6 carbon atoms, corresponding to a LiC₆ stoichiometric limit. This results in a maximum lithium density of 8.8 wt-%. Therefore, the anode material results in an undesirable limitation of the energy density of such batteries.

In place of lithium-intercalation anodes such as graphite, in principle lithium metal or alloys containing lithium metal (e.g. alloys of lithium with aluminum, silicon, tin, titanium or antimony) can be used as anode materials. This principle would allow a substantially higher specific lithium charge and resulting energy density in comparison to conventional graphite intercalation anodes. Unfortunately, such lithium metal-containing systems have unfavorable safety properties and deficient cycle stability. This is mainly a result of the lithium depositing not in planar, but rather in dendritic, form during the deposition in the charging cycle; i.e., needle-shaped outgrowths form on the anode surface. This dendritic outgrowth of lithium can lose the electrical contact with the anode, as the result of which it is electrochemically inactivated; i.e. it can no longer contribute to the anode capacity, and the charge/discharge capacity decreases. Moreover, dendritic-shaped lithium forms may penetrate the separator, which may result in an electrical short circuit of the battery. The short-term release of energy causes a drastic temperature increase, whereby the usually flammable conventional electrolyte solutions containing organic solvents such as carbonic acid esters (for example, ethylene carbonate, propylene carbonate, ethylmethyl carbonate), lactone (e.g. γ-buyrolactone) or ether (e.g. dimethoxyethane) can ignite. Since the present lithium batteries contain a labile fluorine-containing conducting salt (LiPF₆ or LiPF₄), hazardous, corrosive and toxic decomposition products (hydrogen fluoride and volatile fluorine-containing organic products) also form in such instances. For these reasons, rechargeable batteries containing lithium metal have been produced up to now only in micro-construction (e.g. button cells).

Pacific Northwest National Laboratories has suggested additives which can suppress the formation of lithium dendrites (Ji-Guang Zhang, 6^{th} US-China EV and Battery Technology Workshop, August 23, 2012). These additives consist of CsPF₆ or RbPF₆. It is known that the mentioned hexafluorophosphates are not stable in water (E. Bessler, J. Weidlein, Z. Naturforsch. 37b, 1020-1025 (1982).
Rather, they decompose according to
MPF₆+H₂O→POF₃+2HF+MF (M=Cs, Rb, for example)
The liberated hydrofluoric acid is highly toxic and corrosive. For this reason, the production and use of hexafluorophosphates requires the highest-level safety measures. Moreover, in the environmentally friendly waste disposal or recycling of batteries containing MPF₆, measures have to be taken that will prevent the release of toxic fluorine compounds, in particular HF. These precautions are expensive and complicate the recycling of used batteries.

The object of the invention is to provide electrolyte additives which prevent the formation of dendritic lithium structures during the deposition of lithium ions as lithium metal and which are also non-toxic, i.e., in particular do not form any fluorine-containing toxic materials such as HF, POF₃ and the like. These electrolyte additives must have a specific minimum solubility of ≧0.001 mol/L in the solvents which are common for batteries.

The object is achieved in that fluorine-free sodium, potassium, cesium or rubidium salts soluble in polar organic solvents are used as electrolyte components (additives). Additives suitable as such are in particular Na, K, Cs and Rb salts having organoborate anions of the general structure 1, with organophosphate anions of the general structure 2 and/or with perchlorate anion [ClO₄] 3 (M=Na, K, Rb, Cs)

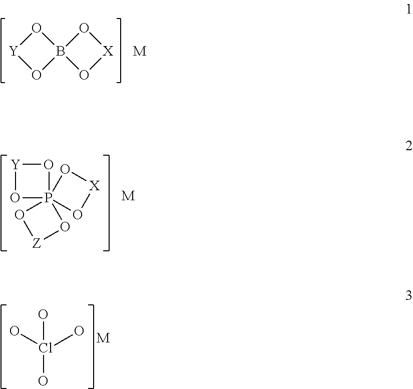

X, Y and Z in formulas 1, 2 represent a bridge, linked by two oxygen atoms to the boron or phosphorus atom, which is selected from

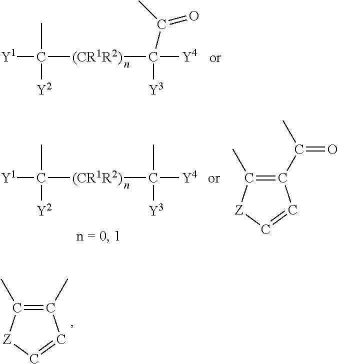

where

Z═N, N═C;

S, S═C;

O, O═C;

C═C,
Y¹ and Y² together mean=O, m=1, n=0 and Y³ and Y⁴ independently of one another are H or an alkyl radical with 1 to 5 C atoms, or
Y¹, Y², Y³, Y⁴ each independently of one another are OR (where R=alkyl radical with 1 to 5 C atoms), H or an alkyl radical R¹, R² with 1 to 5 C atoms, and where m, n=0 or 1.

Compounds of the general formula 1, 2 and/or 3 with M=Rb and Cs are very particularly preferred.

It has surprisingly been found that the fluorine-free Na, K, Cs and Rb salts according to the invention are relatively easily soluble in the aprotic solvents usually used in lithium batteries, such as carbonic acid esters, nitriles, carboxylic acid esters, sulfones, ethers, etc. This was not to be expected, since it is known that many Cs salts having large, weakly coordinating anions are relatively poorly soluble in water (A. Nadjafi, Microchim. Acta 1973, 689-696). Thus, for example, the solubility of CsClO₄ in water at 0° C. is 0.8 g/100 mL, and at 25° C. is 1.97 g/100 mL (Wikipedia, cesium perchlorate). Some solubility data determined in conventional battery solvents by the present applicant are summarized in the table below:

Solubility

| Salt | Solvent | (Wt. %) | (mol/L) |
|---|---|---|---|
| CsBOB | NMP | 7.9 | 0.27 |
| CsBOB | EC/DMC (1:1) | 1.8 | 0.07 |
| CsBOB | PC | 1.5 | 0.06 |
| RbBOB | PC | 0.64 | 0.03 |
| CsBMB | NMP | 1.8 | 0.05 |
| CsClO₄ | PC | 1.3 | 0.07 |

The abbreviation BOB stands for bis-(oxalato)borate (C₄O₈B)⁻, BMB for bis-(malonato)borate (C₆H₄O₈B)⁻, NMP for N-methylpyrrolidone, EC for ethylene carbonate, DMC for dimethyl carbonate, EMC for ethyl methyl carbonate and PC for propylene carbonate.

The above-mentioned compounds are also soluble in electrolyte solutions common for lithium batteries, hence, in the presence of a conducting salt containing lithium. It has surprisingly been found that the additive solubilities are particularly high in the presence of the fluorine salt LiPF₆.

| | | Additive Salt Solubility | |
|---|---|---|---|
| Additive Salt | Supporting Electrolyte | (wt.-%) | (mol/L) |
| CsBOB | LiBOB, 10% EC/EMC | 0.12 | 0.004 |
| CsClO₄ | LiBOB, 10% EC/EMC | 0.12 | 0.005 |
| RbBOB | LiBOB, 10% EC/EMC | 0.03 | 0.001 |
| CsBOB | LiPF₆, 10% EC/EMC | 1.2 | 0.04 |
| CsClO₄ | LiPF₆, 10% EC/EMC | 0.9 | 0.04 |
| RbBOB | LiPF₆, 10% EC/EMC | 1.2 | 0.04 |

The reason for this increased solubility possibly may be that, surprisingly, ligand exchange processes already occur at relatively low temperatures. According to NMR investigations, a significant fluoride/oxalate exchange already takes place at 25° C. within a few days, which in the case of the use of CsBOB can be formulated as follows:

Cs(C₂O₄)₂+LiPF₆ [symbol] CsBF₄+Li[F₂P(C₂O₄)₂]

It was found that electrolyte solutions which contain the above-mentioned fluorine-free additives in concentrations between 0.0001 M and 0.1 M, preferably between 0.001 M and 0.05 M, can prevent the formation of lithium dendrites in galvanic cells with anodes which in the charged state contain or consist of lithium or lithium alloys. The additive according to the invention is preferably used in lithium batteries of the lithium/sulfur or lithium/air type, or with lithium-free or low-lithium cathodes of the conversion or insertion type.

As electrolytes, common types (liquid, gel, polymer and solid electrolytes) known to those skilled in the art are suitable. As conducting salt, lithium salts having weakly coordinated, oxidation-stable anions are used which are soluble or otherwise introducible into such products. These include, for example, LiPF₆, lithium fluoroalkyl phosphates, LiBF₄, imide salts (e.g. LiN(SO₂CF₃)₂), LiOSO₂CF₃, methide salts (e.g. LiC(SO₂CF₃)₃), LiClO₄, lithium chelatoborate (e.g. LiBOB, LiB(C₂O₄)₂), lithium fluorochelatoborates (e.g. LiC₂O₄BF₂), lithium chelatophosphates (e.g. LiTOP, LiP(C₂O₄)₃) and lithium fluorochelatophosphates (e.g. Li(C₂O₄)₂PF₂). Of these conductive lithium salts, the fluorine-free types are particularly preferred, since with use of fluorine the advantages of a completely fluorine-free electrolyte with regard to toxicity and easy handling are lost.

The electrolytes contain a lithium conducting salt or a combination of multiple conductive salts in concentrations of 0.1 mol/kg minimum and 2.5 mol/kg maximum, preferably 0.2 to 1.5 mol/kg. Liquid or gel-form electrolytes also contain organic aprotic solvents, most commonly carbonic acid esters (for example, ethylene carbonate, dimethyl carbonate, diethyl carbonate, fluoroethylene carbonate, propylene carbonate), nitriles (acetonitrile, adiponitrile, valeronitrile, methoxypropionitrile, succinonitrile), carboxylic acid esters (e.g. ethyl acetate, butyl propionate), sulfones (e.g. dimethylsulfone, diethylsulfone, ethylmethoxyethylsulfone), lactones (e.g. γ-butyrolactone) and/or ethers (e.g. tetrahydrofuran, tetrahydropyran, dibutyl ether, 1,2-dimethoxyethane, diethylene glycol dimethyl ether, tetraethylene glycol dimethyl ether, 1,4-dioxane, 1,3-dioxolane).

The compounds according to the invention and preparation thereof are described in general hereinafter.

### EXAMPLES

1. Preparation of Cesium bis(oxalato)borate (CsBOB)

In a 1-L round-bottom glass flask, 38.67 g boric acid and 10.8 g oxalic acid dihydrate were suspended in 121 g water. 102.9 g cesium carbonate was added in portions, with magnetic stirring (vigorous foaming due to CO₂ generation). After the addition was complete, the white suspension was evaporated on a rotary evaporator, initially at 100° C. and 400 mbar. The colorless solid residue was then ground and subjected to final drying at 180° C. and 20 mbar for 3 h.
Yield: 197.3 g of colorless powder (97% of theoretical)
Cs content: 41.0%
67 ¹¹B=7.4 ppm (solution in DMSO-d₆)
Thermal stability: 290° C. (onset of thermal decomposition in the thermogravimetric experiment under argon flow)

### 2. Preparation of a CsBOB-Containing Fluorine-Free Electrolyte Solution

In an Ar-filled glove box, 10 g of an 11 wt.-% LiBOB solution in ethylene carbonate/ethylmethyl carbonate (1:1, wt./wt.) was mixed with 0.32 g CsBOB and magnetically stirred for 24 h. The suspension was then filter-clarified by membrane filtration (0.45 pm PTFE).
Cs content (FES) in the electrolyte solution: 0.05 wt.-%

### 3. Preparation of a CsClO₄-Containing Electrolyte Solution

In an Ar-filled glove box, 10 g of a 10 wt-% LiPF₅ solution in ethylene carbonate/ethylmethyl carbonate (1:1, wt./wt.) was mixed with 0.47 g CsClO₄ and magnetically stirred for 24 h. The suspension was then filter-clarified by membrane filtration (0.45 pm PTFE).
Cs content (FES) in the electrolyte solution: 0.07 wt.-%

1.-12. (canceled)

13. An electrolyte for a galvanic cell containing a metal salt selected from the group of a fluorine-free sodium salt, a fluorine-free potassium salt, a fluorine-free cesium salt and a fluorine-free rubidium salt.

14. The electrolyte according to claim 1, wherein the metal salt is of the formula 1, formula 2 or formula 3: 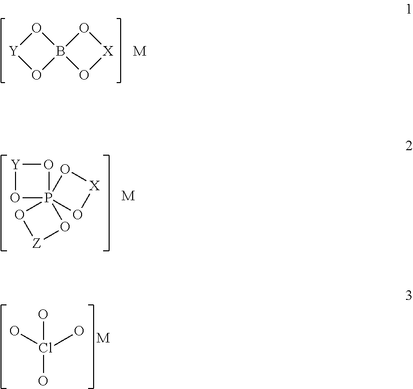
wherein M is Na, K, Cs or Rb;
X, Y and Z in formulas 1, 2 represent a bridge, linked by two oxygen atoms to the boron or phosphorus atom, which is selected from 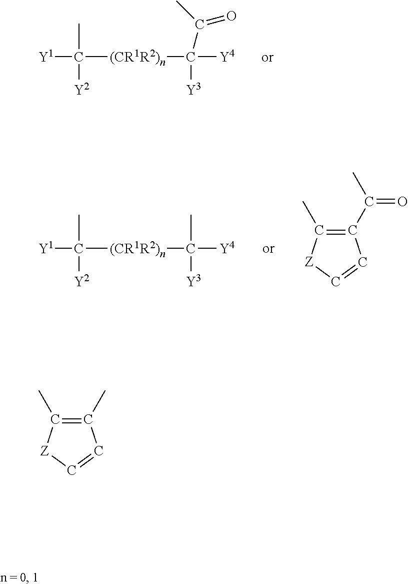
wherein Z is N, N═C; S, S═C, O, O═C or C═C;
Y¹ and Y² together are O,
m i 1,
n is 0; and
Y³ and Y⁴ are independently H or an alkyl radical with 1 to 5 C atoms, or wherein
Y¹, Y², Y³, Y⁴ each independently are OR, wherein R is an alkyl radical with 1 to 5 C atoms, H or an alkyl radical R¹, R² with 1 to 5 C atoms, and wherein m and n are 0 or 1.

15. The electrolyte according to claim 13, wherein the metal salt is a fluorine-free cesium salt or a fluorine free rubidium salt.

16. The electrolyte according to claim 13, wherein the electrolyte contains one or more organic aprotic solvents and a lithium salt having weakly coordinated anions.

17. The electrolyte according to claim 13, wherein the lithium salt is selected from the group LiPF₆, lithium fluoroalkyl phosphates, LiBF₄, imide salts, LiOSO₂CF₃, methide salts, LiClO₄, lithium chelatoborate, lithium fluorochelatoborate, lithium chelatophosphates and lithium fluorochelatophosphates.

18. The electrolyte according to claim 10, wherein the lithium salt is preferably fluorine-free.

19. The electrolyte according to claim 10, wherein the Cs- or Rb-containing additive is present in concentrations between 0.0001 M and 0.1 M.

20. The electrolyte according to claim 10, wherein the Cs- or Rb-containing additive is selected from the group Cs(C₄O₈B), Cs(C₆H₄O₈B), Rb(C₄O₈B), Rb(C₆H₄O₈B), CsClO₄ and RbClO₄.

21. A lithium battery comprising:
in the charged state, a lithium metal or lithium alloy anode, a lithium insertion or conversion cathode, and a lithium ion conductive electrolyte, wherein the electrolyte contains a salt-type, fluorine-free metal salt of claim 14.

22. The lithium battery according to claim 21, wherein the metal salt is selected from the group consisting of Cs(C₄O₈B), Cs(C₆H₄O₈B), Rb(C₄O₈B), Rb(C₆H₄O₈B), CsClO₄ and RbClO₄.

23. A galvanic element which in the charged state comprise a metallic lithium or a lithium alloy and the flourine-free salt of claim 14.

24. A galvanic element comprising:
in the charged state, metallic lithium or a lithium alloy; and
a salt selected from the group consisting of Cs(C₄O₈B), Cs(C₆H₄O₈B), Rb(C₄O₈B), Rb(C₆H₄O₈B), CsClO₄ and RbClO₄ wherein the galvanic element.
